(19) United States
(12) Patent Application Publication
(10) Pub. No.: US 2004/0181989 A1
(43) Pub. Date: Sep. 23, 2004

(54) Photo display system with powered backlighting

(75) Inventor: Alan G. Miller, Austin, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/393,221

(22) Filed: Mar. 20, 2003

(51) Int. Cl. A47G 1/06; G09F 13/04

(52) U.S. Cl. 40/716; 40/564

(57) ABSTRACT

The present invention provides for a photo display system that can quickly and easily be converted from an ambient light backlit viewing mode to a powered backlit viewing mode. The photo display system includes an imaged transparency, a diffuser film disposed next to the imaged transparency and a diffuse reflector.

### CROSS-REFERENCE TO RELATED APPLICATION

The present invention is related to U.S. Patent Application having an attorney docket number 58484US002 filed on the even date herewith.

### FIELD OF THE INVENTION

The present invention relates to a photo display system for use with transparencies. In particular, the present invention relates to a power aided photo display system that uses imaged transparencies.

### BACKGROUND

Powered backlit picture frames for displaying media such as photos, lithographs, and artworks such as paintings and drawings are well known in the art. Examples of some of the patents that disclose backlit or light illuminated displays include U.S. Pat. Nos. 4,942,685 (Lin); 5,247,745 (Valentino); 5,899,012 (Crum); 5,943,801 (Wilkinson); Publication US20010045039A1; and Publication W09966259A1.

There exists a need for other designs for powered backlit or light illuminated photo display systems.

### SUMMARY

In one aspect, the present invention provides a photo display system, comprising (a) a decorative frame, an imaged transparency disposed on the decorative frame, and a diffuser film disposed on the imaged transparency; and (b) a base comprising a power supply that can be put in electrical communication with a light source and an electrical switch, a means for mounting said decorative frame, a first means for attaching a diffuse reflector when said photo display system is in an ambient light backlit viewing mode and a second means for attaching a diffuse reflector when said photo display system is in a powered backlit viewing mode, and wherein said diffuse reflector is disposed behind said decorative frame as viewed from the imaged transparency side of said photo display system.

In another aspect, the present invention provides a method for converting a photo display system described above from an ambient light backlit viewing mode to a powered backlit viewing mode. The method comprises the steps of: (a) providing a photo display system that comprises (i) a decorative frame, an imaged transparency disposed on the decorative frame, and a diffuser film disposed on the imaged transparency, and (ii) a base comprising a power supply that can be put in electrical communication with a light source and an electrical switch, a means for mounting the decorative frame, a first means for attaching a diffuse reflector when the photo display system is in an ambient light backlit viewing mode and a second means for attaching a diffuse reflector when the photo display system is in a powered backlit viewing mode, and wherein the diffuse reflector is disposed in the first means and behind the decorative frame as viewed from the imaged transparency side of the photo display system; (b) removing the diffuse reflector from the first means for attaching a diffuse reflector; (c) expanding the diffuse reflector to create side flaps; (d) installing the expanded diffuse reflector into the second means for attaching the diffuse reflector such that the expanded diffuse reflector forms an enclosure around the decorative frame; and (e) engaging the switch so as to illuminate the light source.

In yet another aspect, the present invention provides a kit for making a photo display system. The kit comprises (a) a decorative frame; (b) an imageable transparency; (c) a diffuser film; (d) a diffuse reflector; and (e) a base comprising a power supply that can be put in electrical communication with a light source and an electrical switch. The base further comprises a means for mounting the decorative frame, a first means for attaching a diffuse reflector when the photo display system is in an ambient light backlit viewing mode, and a second means for attaching a diffuse reflector when the photo display system is in a powered backlit viewing mode.

The above summary of the present invention is not intended to describe each disclosed embodiment or every implementation of the present invention. The figures and detailed description that follow below more particularly exemplify illustrative embodiments.

### BRIEF DESCRIPTION OF THE DRAWINGS

The invention can be further described with the figures below, wherein:

FIG. 1 is a side view of one exemplary embodiment of a photo display system in the ambient light backlit viewing mode in accordance with one aspect of the present invention;

FIG. 2 is a side view of the embodiment in FIG. 1 as the photo display system is being converted from the ambient light backlit viewing mode to a powered backlit viewing mode;

FIG. 3a and 3b are front views of one exemplary embodiment of a diffuse reflector that can be used in accordance with one aspect of the present invention;

FIG. 4 is a side view of the embodiment in FIG. 1 converted to a powered backlit viewing mode;

FIG. 5 is an isometric view of an exemplary base in accordance with one aspect of the present invention;

FIG. 6 is a perspective view of another exemplary embodiment of a photo display system in the ambient light backlit viewing mode in accordance with one aspect of the present invention.

FIG. 7 is a side view of the embodiment of FIG. 6.

FIG. 8 is a schematic view of the exemplary materials that can be used in the present invention.

These figures are idealized, not drawn to scale and are intended only for illustrative purposes.

### DETAILED DESCRIPTION

As described in detail below, an advantage of at least one embodiment of the present invention is that it allows for quick and easy conversion of the photo display system from an ambient light backlit viewing mode to the backlit viewing mode. Due to its unique design and efficient light collection with the diffuse reflector in the ambient light backlit viewing mode, an acceptable location can be found in nearly every case, where an excellent backlit image can be obtained. This backlit image may be from overhead lighting typical in an office environment to daylight from a window. Many other light sources may contribute to typical ambient light. Therefore conversion to the powered backlit viewing mode is only needed under very low light conditions, atypical of conditions under which photo images are typically viewed. Because these viewing conditions are atypical and occur infrequently, it becomes practical to use batteries as the power supply, especially when using light emitting diodes as light sources. Thus, the present invention allows for a light and portable photo display system.

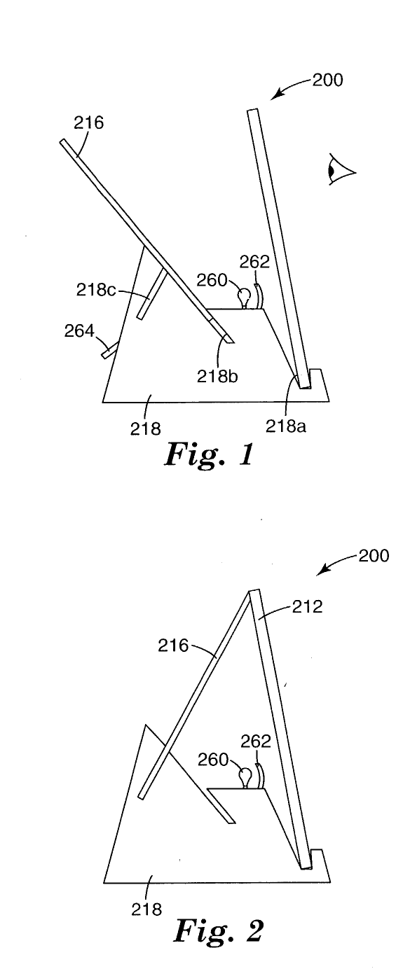

FIG. 1 shows a side view of one exemplary embodiment of the present invention in the ambient light backlit viewing mode. As used in this document, the phrase “ambient light backlit viewing mode” means generally that a viewer relies on the available surrounding light to observe and enjoy the images captured in the photo display system. That is, the photo display system is not lit by a dedicated light source. Photo display system 200, such as a picture frame, contains decorative frame 212 that is disposed on or mounted to base 218. The base includes means for attaching diffuse reflector 216 and means for attaching the decorative frame. In this particular embodiment, the means for attaching the diffuse reflector is through the use of slit 218b and means for attaching the decorative frame is through the use of slot 218a. The base further includes groove 218c for holding the diffuse reflector when the user wants to convert the photo display system from the ambient light backlit viewing mode to a powered backlit viewing mode. As used in this document, the phrase “powered backlit viewing mode” means generally that the viewer relies on a dedicated light source that is connected to a power supply to observe and enjoy the image captured in the photo display system. The base further contains switch 264. Although not shown, a power supply, such as batteries, lies inside the base and has the proper electronic circuitry to the switch and to light source 260, such as light emitting diodes, to power the light source when the user turns switch to the “on” position. In another exemplary embodiment, the power supply lies outside the base. Optional shield 262, disposed between the light source and the decorative frame when the photo display system is in the powered backlit viewing mode, can be used to minimize the appearance of hot spots when viewing the photo display system from the imaged transparency side, as indicated schematically by the eye. As used in this document, the “imaged transparency side” of the photo display system is its front side, i.e., the side that a viewer would use to properly view the image.

FIG. 2 shows the photo display system of FIG. 1 in the process of converting from the ambient light backlit viewing mode to a powered backlit viewing mode. In particular, diffuse reflector 216, which was positioned in slit 281b in the ambient light backlit viewing mode, has been moved to groove 218c such that the top part of the diffuse reflector is in contact with the top of decorative frame 212.

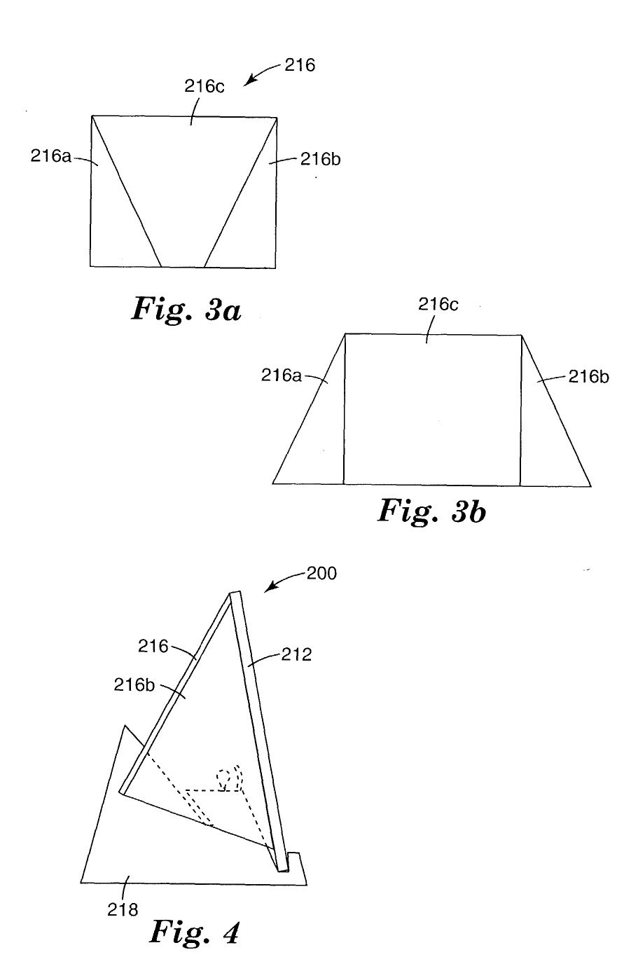

FIG. 3a shows an exemplary diffuse reflector that can be expanded. The diffuse reflector has two flaps, 216a and 216b that are folded over the main body 216c. FIG. 3b shows the embodiment of FIG. 3a where the flaps have been opened, in preparation for converting the photo display system from the ambient light backlit viewing mode to the powered backlit viewing mode as the flaps and main body create an enclosure. In this particular embodiment, the flaps are joined to the main body by use of living hinges. One skilled in the art will recognize that there are other designs for the diffuse reflector to create the enclosure. For example, instead of having flaps 216a and 216b attached to main body 216c, one can have mating grooves attached to the vertical sides of the main body and separately attach the flaps, which were previously stored in a dedicated area on the base.

FIG. 4 shows the embodiment of FIG. 1 fully converted to the backlit viewing mode. Flaps 216a and 216b are opened and form the side walls while main body 216c form the back wall of the enclosure. When the switch is engaged to supply power to the light source, the photo display system is backlit. Because the light source lies inside the enclosure created by diffuse reflector 216 and because the diffuse reflector uses a light enhancement film, as described in detail below, the amount of emitted light loss to the surrounding or absorbed in the photo display system can be minimized.

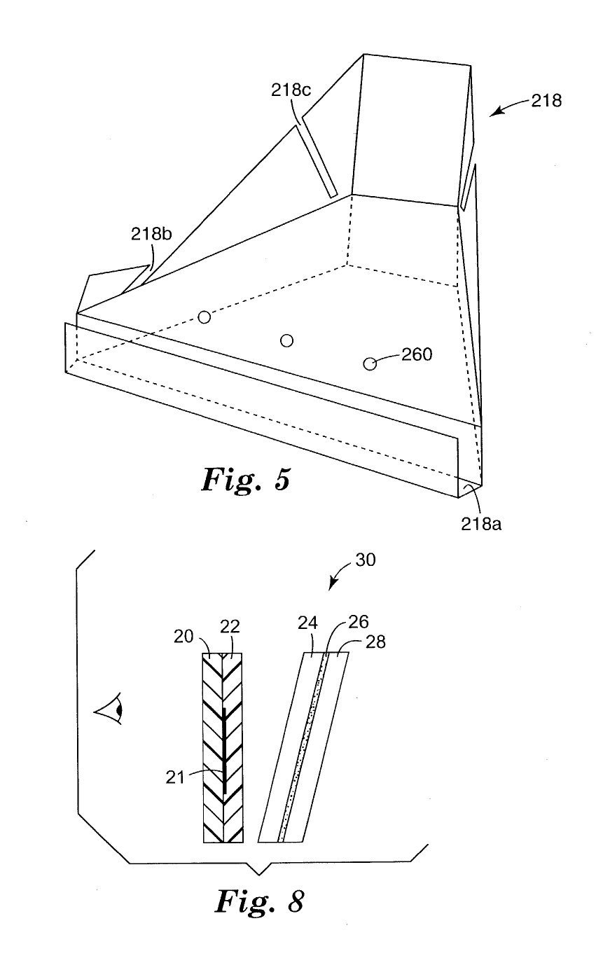

FIG. 5 is a schematic view of an exemplary base that can be used in the present invention. This particular embodiment contains three light sources 260, such as three light emitting diode, that is powered by several batteries (not shown) lying internal to the base. Slit 218b allows for mounting of the diffuse reflector in the ambient light backlit viewing mode and grove 218c allows for mounting of the diffuse reflector in the backlit viewing mode.

FIG. 6 shows a perspective view of another exemplary embodiment of the present invention. Photo display system 10, such as a picture frame, contains decorative frame 12 having border 13 and imaged transparency 15 where an image of a flower is displayed for the viewer. The decorative frame is disposed on or mounted to base 18. The base further contains means for attaching diffuse reflector 16. As further described herein, the imaged transparency is disposed on the decorative frame and the diffuser film is disposed on the imaged transparency.

FIG. 7 shows a side view of another exemplary photo display system where on back surface 13a of border 13 is panel 14 having a plurality of slots 14a. The panel is not solid in that it traces the inside perimeter of the border such that the panel has an opening (not shown) that coincides with an opening on the decorative frame. In one exemplary embodiment, the panel is formed integrally with the border. Various means for mounting the decorative frame to the base can be used. In this particular embodiment, the means for mounting the decorative frame to the base is through stand 18a protruding from the base. The stand is of an appropriate dimension to mate with slot 14a of the panel.

Although FIGS. 1, 2, 4, 6, and 7 show the decorative frame mounted in portrait fashion on the base, it is possible to mount the decorative frame in a landscape fashion by rotating the decorative frame by 90 degrees. For example, in the embodiment shown in FIGS. 6 and 7, because the panel contains slots on each of its side, it is possible to display the image in either portrait or landscape presentation. In the present embodiment, slits 18b or shoulder 18c can serve as means for attaching the diffuse reflector to the base. One skilled in the art will recognize that there are many different designs for the photo display system that can be used in the present invention. For example, in another exemplary embodiment, the decorative frame contains fastening means in place of the panel. One exemplary fastening means is tabs that can rotate from a use position, allowing the imaged transparency and the diffuser film to be held in the decorative frame, to a non-use position, allowing the imaged transparency to be installed or removed from the decorative frame. One skilled in the art will also recognize that there are various ways and various angles at which the diffuse reflector can be positioned on the base. For example, in another exemplary embodiment, the means for mounting the diffuse reflector is designed to allow the diffuse reflector to be adjustable at different angles.

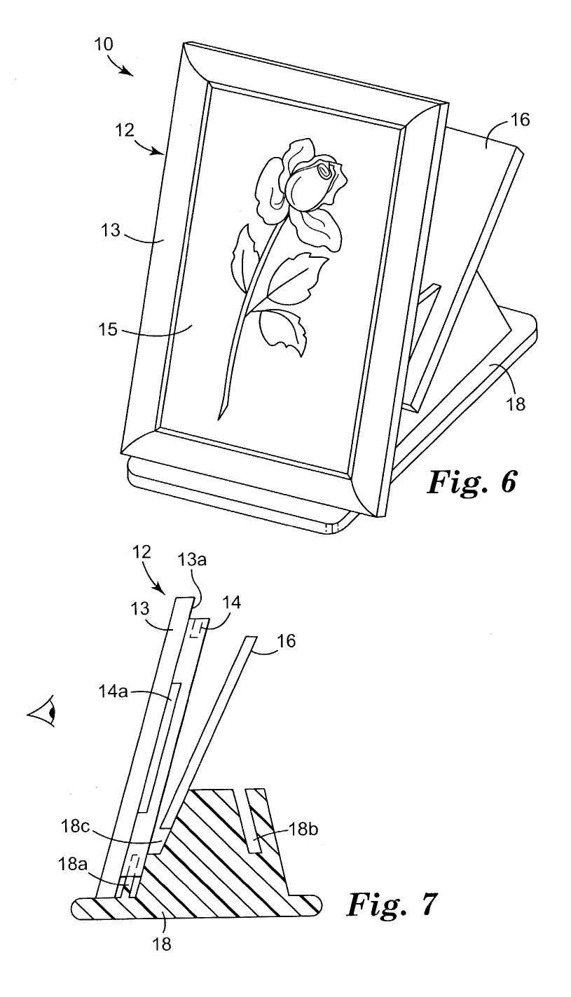

FIG. 8 shows a schematic representation of the various components used in the present invention to produce the photo display system. Imaged transparency 20 is in contact with diffuser film 22. In one exemplary embodiment, that of FIGS. 6 and 7, the imaged transparency diffuser film combination is installed in the decorative frame by inserting the combination into slot 14a of the panel. The imaged transparency contains an image that the viewer wishes to display. The image can be formed on side 20a or side 20b of the transparency. In the case where the image resides on side 20b, the image is typically referred to as being a “buried” image and has the advantage of being protected from dust, fingerprints, and the like, by the transparency itself. In one exemplary embodiment, the diffuse reflector 30 contains light enhancement film 24 having a pressure sensitive adhesive backing 26. The light enhancement film functions to gather ambient light and reflect the light towards the decorative frame. In this particular embodiment, the light enhancement film has been adhesively attached to a substrate 28. These various components are described below in further detail.

As used herein, the term “imaged transparency” means a polymeric film bearing an image thereon, the image typically being created by a printing process. Any polymeric transparency film capable of bearing an image can be used as the imaged transparency in the present invention. In general, the greater the transparency and the lower the image haze, the brighter and more brilliant the image will appear to the viewer. In one exemplary embodiment, the image haze value of the imaged transparency is less than about 30% as measured using the GARNDER HAZE-GARD PLUS haze meter. In another exemplary embodiment, the image haze value of the imaged transparency is less than about 15% as measured using the GARNDER HAZE-GARD PLUS haze meter. The image that eventually appears on the imaged transparency can be created using ink jet printers, electrophotographic printers and copiers, and phase change ink jet printers, i.e., those using solid or phase-change inks.

Useful transparency films that can be used as the imaged transparency with ink jet printers includes 3M™ Transparency Films for Inkjet Printers commercially available from 3M Company, St. Paul, Minn. under product numbers CG3460, CG3480, and CG3490. Useful transparency films that can be used as the imaged transparency with electrophotographic printers and copiers include those commercially available from 3M Company under product designation CG3700, CG3710, CG3720 and CG5000. These transparency films along with the ones listed above are typically polyester based films having various coatings for processing through the different printing methods.

The diffuser film is disposed next to and behind the imaged transparency as shown in FIG. 8 such that when the viewer, looks at the photo display system from the imaged transparency side, the viewer will see the imaged transparency but not the diffuser film. The diffuser film controls the amount of ambient light transmitted to the imaged transparency. The diffuser film also diffuses the ambient light to minimize any appearance of hot spots. In one exemplary embodiment, the diffuser film allows at least 20% of the ambient light to be transmitted. In another exemplary embodiment, the diffuser film allows at most 80% of the ambient light to be transmitted. A commercially available diffuser film can be obtained from the 3M Company from its Commercial Graphics Division under product designations 3M™ Diffuser Film 3635-70. This particular diffuser film allows about 60% of the ambient light to be transmitted. Another useful diffuser film is the 3M™ Diffuser Film 3536-30, which allows about 30% of the ambient light to be transmitted. These films are typically white and will appear uniform in both reflected and transmitted light. The diffuser films are about 0.003 to 0.004 inches (0.08 to 0.10mm) thick. As of the filing date, additional product information on these films can be found on the www.scotchprintgrahics.com web site.

The light enhancement film is disposed behind the diffuser film. The light enhancement film functions to gather ambient light and reflect it to the diffuser. The reflected light is in the form of diffuse light. In one embodiment, the light enhancement film is a flexible polymer sheet having a pressure sensitive backing. When the light enhancement film is laminated to a substrate, a diffuse reflector is formed. The type of substrate upon which the light enhancement film is adhesively attached to is not critical, so long as a good bond is formed between the adhesive and the substrate. On skilled in the art will recognize that there are other light enhancement films available that have the appropriate physical properties, such as rigidity, to be used as a stand alone diffuse reflector. A commercially available diffuser film can be obtained from the 3M Company from its Commercial Graphics Division under product designations 3M™ Light Enhancement Film 3635-100.

The photo display system of the present invention can be used with a base for a traditional picture frame displayed on a desk, bookshelf, fireplace mantle, and the like. The photo display system can also be displayed on windows and walls.

The photo display system of the present invention can also be formed into a kit for a user to reproduce an image and fabricate a personalized photo display system. In one exemplary embodiment of the present invention, the photo display system is packaged in a kit containing at least one transparency ready for imagining, a decorative frame, a panel with or without a diffuser film attached thereto, and a base. In use, the user can assemble the photo display system by installing the diffuse reflector on the base, imaging the transparency with a desired image and attaching it to the decorative frame and mounting the decorative frame on the base thereby display the desired image.

What is claimed is:

1. A photo display system comprising:
(a) a decorative frame, an imaged transparency disposed on said decorative frame, and a diffuser film disposed on said imaged transparency; and
(b) a base comprising a power supply that can be put in electrical communication with a light source and an electrical switch, a means for mounting said decorative frame, a first means for attaching a diffuse reflector when said photo display system is in an ambient light backlit viewing mode and a second means for attaching a diffuse reflector when said photo display system is in a powered backlit viewing mode, and wherein said diffuse reflector is disposed behind said decorative frame as viewed from the imaged transparency side of said photo display system.

2. The photo display system of claim 1, wherein said imaged transparency has a haze value of less than about 30%.

3. The photo display system of claim 1, wherein said imaged transparency is generated from an inkjet printer, an electrographic printer, an electrographic copier, or a phase change inkjet printer.

4. The photo display system of claim 1, wherein said diffuser film allows at least 20% of the ambient light to be transmitted.

5. The photo display system of claim 1, wherein said diffuser film allows about 60% of the ambient light to be transmitted.

6. The photo display system of claim 1, wherein said diffuse reflector comprises a pressure sensitive adhesive backed light enhancement film attached to a substrate.

7. The photo display system of claim 1, wherein said means for mounting said decorative frame is a raised stand.

8. The photo display system of claim 7, wherein said decorative frame further comprises a panel on its rear side said panel having at least one slot that mates with said raised stand, said panel further providing an open pocket for said imaged transparency to reside therein.

9. The photo display system of claim 8, wherein said panel includes a previously attached diffuser film.

10. The photo display system of claim 8, wherein said panel is integrally formed with said decorative frame.

11. The photo display system of claim 1, wherein said power supply is housed inside said base.

12. The photo display system of claim 11, wherein said power supply comprises at least one battery.

13. The photo display system of claim 1, wherein said base further comprises shields disposed in front of said light source as viewed from the imaged transparency side of said photo display system.

14. The photo display system of claim 1, wherein said diffuse reflector comprises expandable portions.

15. The photo display system of claim 14, wherein when photo display system is in a powered backlit viewing mode, said diffuser is disposed in said second means for attaching a diffuse reflector, said diffuse reflector is in contact with a portion of said frame and said diffuse reflector has been expanded to form an enclosure around said decorative frame.

16. The photo display system of claim 1, wherein said power supply comprises at least one battery.

17. A method of converting the photo display system from an ambient light backlit viewing mode to a powered backlit viewing mode, said method comprising the steps of:
(a) providing a photo display system that comprises (i) a decorative frame, an imaged transparency disposed on said decorative frame, and a diffuser film disposed on said imaged transparency, and (ii) a base comprising a power supply that can be put in electrical communication with a light source and an electrical switch, a means for mounting said decorative frame, a first means for attaching a diffuse reflector when said photo display system is in an ambient light backlit viewing mode and a second means for attaching a diffuse reflector when said photo display system is in a powered backlit viewing mode, and wherein said diffuse reflector is disposed in said first means and behind said decorative frame as viewed from the imaged transparency side of said photo display system;
(b) removing said diffuse reflector from said first means for attaching a diffuse reflector;
(c) expanding said diffuse reflector to create side flaps;
(d) installing said expanded diffuse reflector into said second means for attaching said diffuse reflector such that said expanded diffuse reflector forms an enclosure around said decorative frame; and
(e) engaging said switch so as to illuminate said light source.

18. A kit for making a photo display system, said kit comprising:
(a) a decorative frame;
(b) an imageable transparency;
(c) a diffuser film;
(d) a diffuse reflector; and
(e) a base comprising a power supply that can be put in electrical communication with a light source and an electrical switch, a means for mounting said decorative frame, a first means for attaching a diffuse reflector when said photo display system is in an ambient light backlit viewing mode, and a second means for attaching a diffuse reflector when said photo display system is in a powered backlit viewing mode.

19. The kit of claim 18, wherein said kit is assembled by the following method:
(a) imaging said imageable transparency with a desired image to yield an imaged transparency,
(b) attaching said imaged transparency and said diffuser film to said decorative frame such that a viewer sees said desired image when looking at said photo display system;
(c) mounting said decorative frame to said base; and
(d) attaching said diffuse reflector to said base.

20. The kit of claim 19, wherein said imaging step is a process selected from the group consisting of inkjet printing, electrographic printing, electrographic copying, and phase change inkjet printing.

21. The kit of claim 18, wherein said imaged transparency has a haze value of less than about 30%.

22. The kit of claim 18, wherein said diffuser film allows at least 60% of the ambient light to be transmitted.

23. The kit of claim 18, wherein said diffuse reflector comprises a pressure sensitive adhesive backed light enhancement film attached to a substrate.

24. The kit of claim 18, wherein said decorative frame further comprises a panel on its rear side said panel having at least one slot that mates with said raised stand, said panel further providing an open pocket for said imaged transparency to reside therein.

25. The kit of claim 24, wherein said panel includes a previously attached diffuser film.

26. The kit of claim 24, wherein said panel is integrally formed with said decorative frame.

27. The kit of claim 18, wherein said power supply comprises at least one battery.
